(19) United States
(12) Patent Application Publication
(10) Pub. No.: US 2008/0129828 A1
(43) Pub. Date: Jun. 5, 2008

(54) Incident Recording Apparatus

(76) Inventor: Philip Georg Ludovil Luithlen, Leicester (GB)

Correspondence Address: HOWISON & ARNOTT, L.L.P, P.O. BOX 741715, DALLAS, TX, 75374-1715, US

(21) Appl. No.: 11/815,516

(22) PCT Filed: Feb. 3, 2006
(86) PCT No.: PCT/GB06/00375

§ 371 Date: Aug. 3, 2007

(30) Foreign Application Priority Data
Feb. 3, 2005 (GB) GB 05 02200.9

(51) Int. Cl. H04N 5/225

(52) U.S. Cl. 348/207.99

(57) ABSTRACT

The housing, for example of a mobile phone equipped with a camera and a microphone, contains a plurality of discrete memory cards and means for recording data received from the camera and microphone cyclically onto the cards in sequence, overwriting after a given time interval. In the event of seizure of the phone, or if it is dropped, the current memory card is ejected, thus providing a record of the incident to be found, e.g. by the police even though the phone itself may have been stolen. The memory card is so small that the attacker is unlikely to be aware of it. Another application of the apparatus is to a vehicle. Just as violent deceleration actuates air bags it will also cause ejection of the current memory card to provide a record of the accident.

This invention relates to an incident recording apparatus adapted to provide a record of an incident at a location other than that of the camera and/or microphone which has made the recording.

It is in many cases desirable to have a record of incidents occurring in only a few minutes of time. Examples of such incidents are road accidents, assault or vandalism and arrests. One object of the present invention is to provide recording apparatus which continually overwrites data onto the same medium cyclically over a given time span, say five minutes. By this means whenever the recording stops a record is preserved of the preceding five minutes.

It is however desirable that the recording medium should be ejected from the recording apparatus either voluntarily by manual operation or automatically when an unusual event is detected by the apparatus. The reason for this is that the recording apparatus itself is likely to be a target in the event of criminal activity. The criminal will want to destroy the record or simply to steal the apparatus. This will particularly be the case if, for example, the apparatus of the invention is installed in a mobile or cell phone.

Memory cards are now very small items. If a memory card is ejected from, for example, a mobile phone it will be difficult to find in the heat of the moment, but nevertheless it will be present on the scene to be found by meticulous search. For example if a person carrying the phone is assaulted the perpetrator may make off with the phone but even if the perpetrator is aware that a memory card has been ejected it will be difficult and time consuming to find it, especially in the dark or poor weather conditions. On the other hand the police investigating the crime scene will have the leisure and resources to find it. It will then hopefully provide information leading to the arrest of the perpetrator.

When installed in a vehicle the apparatus of the invention may respond to the rapid deceleration which will occur in an accident to eject the current memory card. When installed in a mobile phone it may respond to the phone being dropped or simply to the release of a “dead man's handle” facility. Owners will be advised to carry the phone in the hand when in potentially dangerous situations. The phone may be provided with a button held depressed as long as the phone is grasped but which will default when the button is released, thus ejecting the current memory card. Alternatively or in addition the current memory card will be ejected if the phone receives an impact, for example if it is dropped. Therefore a potential rape or robbery victim, for example, crossing a lonely common in the dark will hold the phone in one hand. If someone attempts to seize the phone or if the victim is caused to drop the phone the current memory card will be ejected.

In accordance with the present invention there is provided incident recording apparatus comprising means for receiving data from a camera and/or a microphone, a housing having an ejection slot, a plurality of discrete memory cards within the housing, means within the housing for cyclically recording data received from the camera and/or microphone onto the memory cards in sequence from one memory card to the next, overwriting the cards on completion of each cycle, and means for ejecting at least the memory card on which data is currently being recorded in response to a predetermined incident.

In a preferred embodiment of the invention the data received is digital and is divided into successive frames representing successive time periods and successive frames are recorded on respective memory cards. The respective memory cards are preferably successive. By this arrangement every memory card will contain frames recorded over a period longer than the time-capacity of individual memory cards, so that an ejected memory card will have a more complete record of events prior to the incident than it would otherwise have.

The predetermined incident may comprise manual operation of an ejection means. This operation may be by the release rather than the depression of a button on the housing. Alternatively, or in addition, the predetermined incident may comprises rapid deceleration of, or an impact received by, the housing.

The camera and/or microphone may be built into the housing and the housing may also contain a mobile or cell phone.

Preferably each said memory card is generally rectangular in section and no more than 5 mm wide by 2 cm long by 3 mm thick.

Each memory card may have means for generating a signal after a predetermined time delay following its ejection. The time delay is to prevent the signal assisting an attacker to locate the memory card but following the delay the signal will assist e.g. the police to locate the memory card.

The signal may be visible or auditory or capable of detection only by specific equipment such as an infra red detector or a metal detector.

A preferred embodiment of the invention will now be described with reference to the accompanying drawings, in which:

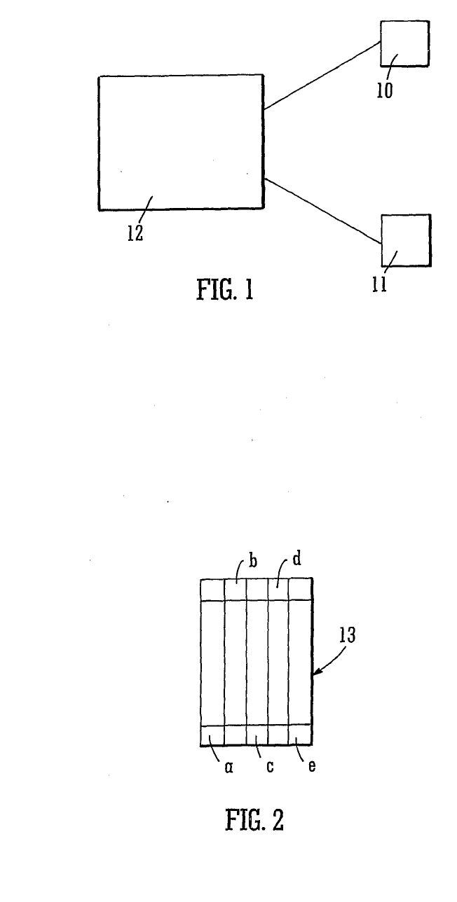

FIG. 1 schematically illustrates the relevant components of apparatus according to the invention, and

FIG. 2 illustrates plural, discrete memory cards in a side-by-side relation.

A camera 10 and a microphone 11 send data to recording apparatus 12 in which a plurality of discrete memory cards 13 are located. The recording apparatus 12 is adapted continuously to record from one memory card to the next and at the end of the cycle to overwrite the data previously recorded. As an example, the cycle may be five minutes, each of the five memory cards 13 receiving one minute's worth of data. At the end of the five minute cycle the recording apparatus will start overwriting the memory cards in sequence, so that at any given moment the apparatus contains a record of the previous five minutes. The memory card selected to be ejected from the apparatus through a slot in its housing (not shown) if a predetermined event occurs is the memory card on which data is being recorded when the event occurs.

Preferably the camera and/or microphone provide data in digital form as bits of data representing successive time periods, for example a single frame of video data, piece of audio information or other data at or over a particular point in time. Preferably successive frames or blocks of data are recorded on different memory cards. In the example illustrated the five memory cards 13 each have a capacity to store 60 frames of video data and 60 seconds of audio data before they are overwritten, so that at any given moment they collectively store 300 frames of video data and 5 minutes of audio information. However successive frames are not recorded on the same memory card. Say that each memory card holds 60 frames. A first frame is recorded on card a, the next on card b and so on. At a recording rate of five frames per second, video data from a one second time period will be stored equally across the five memory cards as a single frame on each card. After one minute of recording each card will contain 60 frames of data and will be full. The cards will collectively have stored 300 frames. In order to continue storing frames a 301^{st} frame will be recorded on card a, overwriting the first frame (frame 1) on that card, a 302^{nd} frame will be recorded on card b overwriting the first frame (frame 2) stored on that card, a 303^{rd} frame will be recorded on card c overwriting the first frame (frame 3) on that card and so on. Thus each card will contain one minute of recording made up of 60 frames with each frame separated by one second in time. As each card in this example holds 60 seconds of audio data all five memory cards will individually hold a complete record of audio information for the past minute. As memory storage increases in the future the cards may contain duplicate frame data.

The ejected memory card or cards will contain a record, albeit fragmentary, extending over a sufficient period prior to the incident giving rise to its ejection, in the present example one minute prior including 60 frames at one second intervals. This is likely to be more useful than if successive frames are stored on the same card where there may be a record of the previous 12-24 seconds but not the previous 1-12 seconds. Through storing successive frames on individual cards only one ejected card needs to be recovered to access frames from each second of the previous minute.

This predetermined event may consist in an attempt to vandalise or steal the apparatus or, if mounted in a vehicle, the apparatus may respond to the violent deceleration which will occur in an accident. The apparatus may be connected to a satellite navigation system of the vehicle so as to provide information as to the location of the vehicle when the event occurred. If the apparatus is associated with a mobile or cell phone, for example sharing its housing, the ejection means may be actuated by an impact to the housing caused by its being dropped. In any event the apparatus preferably includes manually operable means for ejecting the selected memory card and this manually operable means may be adapted to be actuated by the release as opposed to the depression of a button (not shown) of the housing. Thus if the apparatus is hand carried it will respond to its theft or to being dropped.

At least the memory card on which data is being recorded when the event occurs is ejected but other cards or indeed all of the cards may be simultaneously ejected. Furthermore the ejection of memory cards may be remotely controlled, for example by a telephone signal.

The apparatus may be associated with a firearm, ejecting one or more memory cards when the firearm is fired to provide a record of the event.

The apparatus of the present invention need not include a camera or microphone provided it has means for receiving data from a camera or microphone by wireless transmission, such as Bluetooth. For example the apparatus of the invention may be adapted to respond to a wireless transmission from a camera or microphone installed, for example, at a cash point or on board a train.

It is preferable that each memory card is equipped with means (not shown) for emitting a signal after a predetermined time delay following its ejection. For example it may be self-illuminating or adapted to emit a sound signal. This will assist in its recovery by the authorities but the time delay is designed to prevent the signal from assisting an attacker or thief.

While it is preferable that the apparatus should record both visual and auditory data it is not essential that both a camera and a microphone are provided. When used as part of a CCTV surveillance system, for example, the microphone may be omitted.

1. Incident recording apparatus comprising means for receiving data from a camera and/or a microphone, a housing having an ejection slot, a plurality of discrete memory cards within the housing, means within the housing for cyclically recording data received from the camera and/or microphone onto the memory cards in sequence from one memory card to the next, overwriting the cards on completion of each cycle, and means for ejecting at least the memory card on which data is currently being recorded in response to the occurrence of a predetermined incident.

2. Apparatus as claimed in claim 1, wherein the data received is digital and is divided into successive frames representing successive time periods and wherein successive frames are recorded on respective memory cards.

3. Apparatus as claimed in claim 2, wherein the respective memory cards are successive.

4. Apparatus as claimed in any one of the preceding claims, wherein the predetermined incident comprises manual operation of an ejection means.

5. Apparatus as claimed in claim 4, wherein the ejection means is actuated by the release of a button of the housing.

6. Apparatus as claimed in any one of the preceding claims, wherein the predetermined incident comprises rapid deceleration or impact of the housing.

7. Apparatus as claimed in any one of the preceding claims, wherein the camera and/or microphone is or are built into the housing.

8. Apparatus as claimed in any one of the preceding claim wherein the housing also contains a mobile or cell phone.

9. Apparatus as claimed in any one of the preceding claims, wherein each said memory card is generally rectangular in section and no more than 5 mm wide by 2 cm long by 3 mm thick.

10. Apparatus as claimed in any one of the preceding claims, wherein each memory card has means for generating a signal after a predetermined time delay following its ejection.

11. Apparatus as claimed in claim 10, wherein the signal is visible or auditory or capable of detection only by specific equipment.
